(19) United States
(12) Patent Application Publication
(10) Pub. No.: US 2025/0171326 A1
(43) Pub. Date: May 29, 2025

(54) PREPARING METHOD OF RARE EARTH COMPOSITE OXIDE PARTICLES

(71) Applicant: Shin-Etsu Chemical Co., Ltd., Tokyo (JP)

(72) Inventor: Hironori Suzuki, Echizen-shi (JP)

(73) Assignee: Shin-Etsu Chemical Co., Ltd., Tokyo (JP)

(21) Appl. No.: 18/939,696

(22) Filed: Nov. 7, 2024

(30) Foreign Application Priority Data
Nov. 27, 2023 (JP) 2023-199867
Sep. 2, 2024 (JP) 2024-150443

(51) Int. Cl. C01F 17/34; C01G 15/00

(52) U.S. Cl. CPC C01F 17/34; C01G 15/00; C01P 2004/01; C01P 2004/51; C01P 2004/61; C01P 2004/62

(57) ABSTRACT

A rare earth composite oxide particles is prepared by a method including the steps of (A) producing particles of rare earth composite compound by heating an aqueous solution that contains ions of at least one kind of rare earth element selected from the group consisting of Sc, Y, Nd, Gd, Tb, Dy, Ho, Er, Tm, Yb, and Lu, either or both of Al ions and Ga ions, an organic compound having a carboxy group, and urea at not less than 80° C. and not more than a boiling point of the aqueous solution to react the organic compound, a hydrolyzed product of the urea, the ions of the rare earth element, and the either or both of Al ions and Ga ions, and (B) producing rare earth composite oxide from the rare earth composite compound.

### CROSS-REFERENCE TO RELATED APPLICATIONS

This non-provisional application claims priority under 35 U.S.C. § 119(a) on Patent Application Nos. 2023-199867 and 2024-150443 filed in Japan on Nov. 27, 2023 and Sep. 2, 2024, respectively, the entire contents of which are hereby incorporated by reference.

### TECHNICAL FIELD

The present invention relates to a preparing method of rare earth composite oxide particles containing either or both of aluminum and gallium that is useful for a raw material for ceramics.

### BACKGROUND ART

Composite oxides containing a rare earth element are used in various functional ceramic products, and contribute to improvement of properties of the products. Raw material powders of rare earth composite oxides containing aluminum or gallium are used by various means to manufacture ceramics, phosphors, thin films, coatings or others. Recently, demands to finer raw material powders have been increased to improve the properties of functional ceramic products in many cases.

As a method for obtaining fine particles of a rare earth carbonate or a rare earth oxide, for example, a method is described in JP-A 2000-239019 (Patent Document 1). In this method, urea is hydrolyzed by heating in water in the coexistence of hydrogen peroxide, and a basic carbonate of a rare earth element, as monodisperse particles, is precipitated from rare earth element ions, then separated by solid-liquid separation, dried, and calcined to obtain a rare earth oxide.

Further, as a method for obtaining a composite compound and a composite oxide of a metal element, for example, a method is described in JP-A 2018-095524 (Patent Document 2). In this method, metal compounds containing respective metal element components which constitute a perovskite-type composite oxide, and a dicarboxylic acid compound are dissolved in a solvent to obtain a solution, then the solution is dried up and calcinated to obtain a composite oxide of the metal elements.

However, when ions of metal element other than rare earth elements, which is easily hydroxylated and gelled such as aluminum and gallium, and rare earth element ions are precipitated by the method described in JP-A 2000-239019 (Patent Document 1), a composite compound containing the rare earth element that has poor property for collecting is obtained due to gelation of hydroxylated aluminum and gallium. In addition, when the obtained composite compound is calcined, due to dehydration condensation of the hydroxides, the rare earth composite oxide containing aluminum or gallium results in strongly aggregated and enlarged particles.

Further, in the method described in JP-A 2018-095524 A (Patent Document 2), the solution prepared by dissolve the metal compounds containing the metal element components, and the dicarboxylic acid compound in the solvent is dried up using a rotary evaporator to obtain the composite compound of the metal elements, thus, this method has poor productivity in terms of mass production on an industrial scale.

### CITATION LIST

Patent Document 1: JP-A 2000-239019
Patent Document 2: JP-A 2018-095524

### SUMMARY OF THE INVENTION

The present invention has been made under consideration of the above circumstances, and an object of the present invention is to provide a preparing method in which rare earth composite oxide particles containing either or both of aluminum and gallium are prepared with suppressing gelation and without enlarging particles, and to provide a preparing method of rare earth composite oxide particles containing either or both of aluminum and gallium that has high productivity and advance in mass production.

In a homogeneous precipitation method, particles of a rare earth compound such as a basic carbonate of a rare earth element can be precipitated by heating an aqueous solution containing a rare earth mineral acid salt, which is an ion source of the rare earth element, and urea. However, in the case of a metal element such as aluminum and gallium, particles of a metal compound such as a hydroxide salt precipitate from a low pH range, and the particles are gelled, and enlarged since the particles tend to bond with each other. When a homogeneous precipitation method is performed in the coexistence of both of the metal element which is easily gelled, and the rare earth element, gelation occurs and enlarged particles are obtained.

The inventor has made earnestly studies to solve the above problems with respect to a preparing method of rare earth composite oxide particles containing either or both of aluminum and gallium by a homogeneous precipitation method. As a result, the inventor found that the gelation and enlargement of the precipitated particles are improved by heating an aqueous solution containing an organic compound having a carboxy group with a rare earth element, and either or both of aluminum and gallium, and highly dispersed rare earth composite oxide particles containing either or both of aluminum and gallium can be prepared.

In one aspect, the invention provides a preparing method of rare earth composite oxide particles, including the steps of:
(A) producing particles of rare earth composite compound by heating an aqueous solution that contains ions of at least one kind of rare earth element selected from the group consisting of Sc, Y, Nd, Gd, Tb, Dy, Ho, Er, Tm, Yb, and Lu, either or both of Al ions and Ga ions, an organic compound having a carboxy group, and urea at not less than 80° C. and not more than a boiling point of the aqueous solution to react the organic compound, a hydrolyzed product of the urea, the ions of the rare earth element, and the either or both of Al ions and Ga ions, and
(B) producing rare earth composite oxide from the rare earth composite compound.

Preferably, the organic compound is an organic compound having at least one carboxy group, or an organic compound having condensed carboxy groups from which carboxy groups are easily formed in the aqueous solution.

Preferably, the step (B) includes the steps of:
separating the particles of the rare earth composite compound obtained in the step (A) by solid-liquid separation, and
calcining the obtained solid under an atmosphere containing oxygen at not less than 600° C. to produce the rare earth composite oxide.

Preferably, the method is for preparing the rare earth composite oxide particles having a volume-based median diameter (D50) of not less than 0.1 μm and not more than 10 μm in particle size distribution measured by a laser diffraction method.

Preferably, the organic compound having a carboxy group is at least one kind selected from the group consisting of maleic acid, maleic anhydride, malic acid, and citric acid.

Preferably, the step (B) includes the steps of:
separating the particles of the rare earth composite compound obtained in the step (A) by solid-liquid separation, and
calcining the obtained solid under an atmosphere containing oxygen at not less than 700° C. to produce the rare earth composite oxide.

### Advantageous Effects of the Invention

According to the invention, by adding an organic compound having a carboxy group to an aqueous solution for precipitating rare earth composite compound particles containing either or both of aluminum and gallium, even when a metal element such as aluminum and gallium, which tends to gel and to produce enlarged particles, are included, gelation and enlargement of particles are suppressed compared to conventional methods, and particles having good dispersibility are obtained. Therefore, the method makes it possible to mass-produce fine particles exerting high performance that accommodate recent trend toward finer particles for ceramic raw materials.

### BRIEF DESCRIPTION OF THE DRAWINGS

FIG. 1 is an electron microscope image of the rare earth composite oxide particles obtained in Example 1, and an electron microscope photograph of yttrium-aluminum composite oxide particles.

FIG. 2 is an electron microscope image of the rare earth composite oxide particles obtained in Example 2, and an electron microscope photograph of yttrium-aluminum composite oxide particles.

FIG. 3 is an electron microscope image of the rare earth composite oxide particles obtained in Example 3, and an electron microscope photograph of yttrium-aluminum composite oxide particles.

FIG. 4 is an electron microscope image of the rare earth composite oxide particles obtained in Example 4, and an electron microscope photograph of yttrium-aluminum gallium composite oxide particles.

FIG. 5 is an electron microscope image of the rare earth composite oxide particles obtained in Example 5, and an electron microscope photograph of lutetium-aluminum composite oxide particles.

FIG. 6 is an electron microscope image of the rare earth composite oxide particles obtained in Example 6, and an electron microscope photograph of gadolinium-gallium composite oxide particles.

FIG. 7 is an electron microscope image of the rare earth composite oxide particles obtained in Comparative Example 1, and an electron microscope photograph of yttrium-aluminum composite oxide particles.

FIG. 8 shows the result of particle size distribution measurement for the yttrium-aluminum composite oxide particles obtained in Example 1 by a laser diffraction method.

FIG. 9 shows the result of particle size distribution measurement for the yttrium-aluminum composite oxide particles obtained in Example 2 by a laser diffraction method.

FIG. 10 shows the result of particle size distribution measurement for the yttrium-aluminum composite oxide particles obtained in Example 3 by a laser diffraction method.

FIG. 11 shows the result of particle size distribution measurement for the yttrium-aluminum gallium composite oxide particles obtained in Example 4 by a laser diffraction method.

FIG. 12 shows the result of particle size distribution measurement for the lutetium-aluminum composite oxide particles obtained in Example 5 by a laser diffraction method.

FIG. 13 shows the result of particle size distribution measurement for the gadolinium-gallium composite oxide particles obtained in Example 6 by a laser diffraction method.

FIG. 14 shows the result of particle size distribution measurement for the yttrium-aluminum composite oxide particles obtained in Comparative Example 1 by a laser diffraction method.

### DETAILED DESCRIPTION OF THE INVENTION

In the invention, rare earth composite oxide particles are prepared by a method including the steps of:
(A) producing particles of rare earth composite compound by heating an aqueous solution that contains ions of at least one kind of rare earth element selected from the group consisting of Sc, Y, Nd, Gd, Tb, Dy, Ho, Er, Tm, Yb, and Lu, either or both of Al ions and Ga ions, an organic compound having a carboxy group, and urea at not less than 80° C. and not more than a boiling point of the aqueous solution to react the organic compound, a hydrolyzed product of the urea, the ions of the rare earth element, and the either or both of Al ions and Ga ions, and
(B) producing rare earth composite oxide from the rare earth composite compound.

In the invention, an aqueous solution containing ions of a rare earth element, either or both ions of aluminum (Al) and gallium (Ga) which is easily gelled, an organic compound having a carboxy group, and urea is heated, and a rare earth composite compound containing either or both of aluminum and gallium is produced by reaction of the organic compound, a hydrolyzed product of the urea, the ions of the rare earth element, and either or both of aluminum ions and gallium ions to prepare fine particles of the rare earth composite compound containing either or both of aluminum and gallium.

The aqueous solution containing ions of the rare earth element, and either or both of aluminum ions and gallium ions, and further containing optionally ions of another metal element described later may be provided by preparing an aqueous solution of a water-soluble rare earth mineral salt, and a mineral salt of either or both of aluminum and gallium, and an optional mineral salt of the other metal element described later. Examples of the mineral salts include nitrates and chlorides. When a metal such as iron and stainless steel is used for parts inside of a preparing equipment that contact with the aqueous solution, it is more preferable to use nitrates that have less possibility to increase impurities in the product that are derived from the metal of the parts contacted with the aqueous solution.

As the ion of the rare earth element, an ion of at least one kind of rare earth element (first rare earth element) selected from the group consisting of Sc, Y, Nd, Gd, Tb, Dy, Ho, Er, Tm, Yb, and Lu are contained. A preferable concentration of the ions of the first rare earth element in the aqueous solution is not less than 0.01 mol/L, particularly not less than 0.05 mol/L, and not more than 0.3 mol/L, particularly not more than 0.2 mol/L. A high concentration of the ions of the rare earth element is preferable in view of productivity of particles, however, the particles may be strongly aggregated at a concentration more than 0.3 mol/L.

Further, as the ions of the rare earth element, ions of the rare earth element (second rare earth element) other than the first rare earth element may be contained in addition to the ions of the first rare earth element. As the ion of the second rare earth element, an ion of at least one kind of rare earth element selected from the group consisting of La, Ce, Pr, Sm and Eu are exemplified. In the case of containing the second rare earth element, a preferable concentration of the total of the ions of the first rare earth element and the ions of the second rare earth element in the aqueous solution is not less than 0.01 mol/L, particularly not less than 0.05 mol/L, and not more than 0.3 mol/L, particularly not more than 0.2 mol/L. Among the ions of the first rare earth element and the ions of the second rare earth element, a preferable content of the ions of the second rare earth element to the total of the ions of the first rare earth element and the ions of the second rare earth element is not more than 50 mol %, particularly not more than 30 mol %.

A preferable concentration of the total of aluminum and gallium in the aqueous solution is not less than 0.01 mol/L, particularly not less than 0.05 mol/L, and not more than 0.3 mol/L, particularly not more than 0.2 mol/L. A high concentration of aluminum and gallium is preferable in view of productivity of particles, however, the particles may be strongly aggregated at a concentration more than 0.3 mol/L. In the case that the aqueous solution contains both the ions of aluminum and the ions of gallium, a ratio of the ions of aluminum and the ions of gallium is not particularly limited. A preferable content of ions of gallium to the total of the ions of aluminum and the ions of gallium is not more than 50 mol %, particularly not more than 40 mol %.

The aqueous solution containing the ions of the rare earth element, and either or both of the ions of aluminum and the ions of gallium may further contain ions of metal (ions of another metal) other than the first rare earth element, the second rare earth element, aluminum and gallium in addition to either or both of the ions of aluminum and the ions of gallium. As the ion of the other metal, an ion of iron is exemplified. In the case of containing the ions of the other metal, a preferable concentration of the total of the ions of aluminum, the ions of gallium, and the ions of the other metal in the aqueous solution is not less than 0.01 mol/L, particularly not less than 0.05 mol/L, and not more than 0.3 mol/L, particularly not more than 0.2 mol/L. Among the ions of aluminum, the ions of gallium and the ions of the other metal, a preferable content of the ions of the other metal to the total of the ions of aluminum, the ions of gallium, and the ions of the other metal is not more than 50 mol %, particularly not more than 40 mol %.

A preferable concentration of the total of the ions of the rare earth element, the ions of gallium, and the ions of aluminum, or a preferable concentration of the total of the ions of the rare earth element, the ions of aluminum, the ions of gallium, and the ions of the other metal in the case of containing the ions of the other metal in the aqueous solution is not less than 0.02 mol/L, particularly not less than 0.1 mol/L, and not more than 0.6 mol/L, particularly not more than 0.3 mol/L. A high concentration of the total of the ions of the rare earth element, the ions of aluminum, the ions of gallium, and the ions of the optional other metal is preferable in view of productivity of particles, however, the particles may be strongly aggregated at a concentration more than 0.3 mol/L.

An organic compound having a carboxy group is contained in the aqueous solution. As the organic compound having a carboxy group, an organic compound having at least one carboxy group, or an organic compound having condensed carboxy groups from which carboxy groups are easily formed in the aqueous solution is exemplified. The organic compound having a carboxy group is preferably at least one kind selected from the group consisting of maleic acid, maleic anhydride, malic acid, and citric acid.

A preferable amount of the organic compound having a carboxy group to the total amount of the ions of the rare earth element, the ions of aluminum, the ions of gallium, and the ions of the optional other metal in the aqueous solution is not less than 0.1 times, particularly not less than 0.2 times, and not more than 1 time, particularly not more than 0.5 times in molar ratio. When the amount of the organic compound having a carboxy group is less than the above range, gelation may not be sufficiently suppressed. When the amount of the organic compound having a carboxy group exceeds the above range, a highly water-soluble compound may be formed from the ions of the rare earth element, the ions of either or both of aluminum and gallium, and ions of the optional other metal together with the organic compound having a carboxy group, and a recovery amount (yield) of the rare earth composite compound which is a precipitate may decrease.

Urea is contained in the aqueous solution. A preferable amount of urea to the total amount of the ions of the rare earth element, the ions of aluminum, the ions of gallium, and the ions of the optional other metal in the aqueous solution is not less than 5 times, particularly not less than 10 times, and not more than 30 times, particularly not more than 20 times in molar ratio. When the amount of the urea is less than the above range, production time of the rare earth composite compound may be too long, and a recovery amount (yield) of the rare earth composite compound may decrease. When the amount of the urea exceeds the above range, it may be disadvantageous in terms of economic efficiency.

The organic compound having a carboxy group and urea may be mixed to the ions of the rare earth element, the ions of either or both of aluminum and gallium, and ions of the optional other metal either before heating, or after the start of heating, i.e., during heating (while the temperature is rising or after the temperature has been reached to a predetermined temperature).

In a preparing of the rare earth composite compound containing either or both of the ions of aluminum and gallium, the rare earth composite compound containing either or both of the ions of aluminum and gallium is produced as a precipitate by heating the aqueous solution (mixed aqueous solution) containing respective components to hydrolyze the urea and to react hydrolyzed products generated by the hydrolysis such as carbonate ions and ammonium ions, and the organic compound having a carboxy group with the ions of the rare earth element. A preferable heating temperature is not less than 80° C., particularly not less than 90° C., and not more than a boiling point, particularly less than a boiling point, of the mixed aqueous solution, for example, more preferably not more than 100° C. A heating time may be shortened when the additive amount of urea is much and the heating temperature is high, and is generally 60 to 300 minutes.

The precipitate (solid) is generated in the form of a slurry, and can be separated into solid and liquid by a method such as filtration, or sedimentation such as decantation and centrifugation. The obtained precipitate is very small particles, it is preferable to separate the precipitate into solid and liquid by a centrifugal sedimentation method since the particles are more likely to pass through a filter by normal filtration. When unreacted urea and residual anions contained in the solid are removed, the solid obtained after solid-liquid separation is preferably washed with pure water or others. The solid may be further dried under an oxygen-containing atmosphere such as the air or under an inert gas atmosphere, if needed. The particles of the rare earth composite compound containing either or both of the ions of aluminum and gallium obtained in this way contain carbonates, basic carbonates, hydroxides, or others, depending on the kind of the rare earth element.

The rare earth composite compound particles containing either or both the ions of aluminum and gallium, which is obtained as a solid may be used as is. Further, the rare earth composite compound may be calcinated to produce rare earth composite oxide from the rare earth composite compound, and particles of the rare earth composite oxide containing either or both the ions of aluminum and gallium such as garnet, monoclinic, and perovskite can be prepared. After solid-liquid separation, when the rare earth composite compound containing either or both of the ions of aluminum and gallium collected as a solid is calcinated as is, a clumpy solid will be formed due to aggregation and sintering in many cases. Therefore, in order to recover the rare earth composite oxide obtained after calcinating as particles having good dispersibility, after the solid-liquid separation, it is preferable to calcinate the compound after drying. A preferable temperature for this drying is not more than 150° C., particularly not more than 80° C., especially not more than 60° C. Depending on the kind of the rare earth element, when the drying temperature is too high, the rare earth composite compound may be recrystallized, and may lose the characteristic as particles. A preferably drying time is not less than one day (24 hours), and is generally not more than seven days (168 hours), however, not particularly limited thereto. An atmosphere for the drying is not particularly limited, and may be an oxygen-containing atmosphere such as the air, or an inert gas atmosphere.

The dried rare earth composite compound containing either or both of the ions of aluminum and gallium can be crushed by a crusher or others. The dried particles of the rare earth composite compound containing either or both of ions of aluminum and gallium is easily separated by crushing with a relatively weak force, since it is considered that the particles are bounded to each other by very weak forces such as hydrogen bond. The crusher may be a jet mill, a roll mill, a hammer mill, a bead mill, a ball mill, or others, and may be selected appropriately depending on the state of the particles to be obtained by the crushing.

Calcination to obtain a rare earth composite oxide containing either or both of the ions of aluminum and gallium is preferably performed under an oxygen-containing atmosphere such as the air or oxygen gas at a preferable temperature of not less than 600° C., particularly not less than 700° C., especially not less than 800° C., and not more than 1500° C., particularly not more than 1300° C. A preferable calcination time is not less than 2 hours, and generally not more than 8 hours.

By the method of the invention, rare earth composite oxide particles containing either or both of the ions of aluminum and gallium that has a median diameter (D50) of not less than 0.1 μm and not more than 10 μm in particle size distribution measured by a laser diffraction method can be obtained.

### EXAMPLES

Examples of the invention are given below by way of illustration and not by way of limitation.

### Example 1

An aqueous solution of yttrium nitrate and an aqueous solution of aluminum nitrate were added so that the yttrium ion concentration was 0.06 mol/L, and the aluminum ion concentration was 0.10 mol/L, respectively, in 100 L of the aqueous solutions. Further, maleic anhydride was added at an amount corresponding to 0.4 times of the total ion concentration of yttrium ions and aluminum ions, then the solution was stirred. Next, the solution was heated to 98° C., then urea was added at an amount corresponding to 2.4 mol/L, and the solution was heated at 98° C. for 150 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

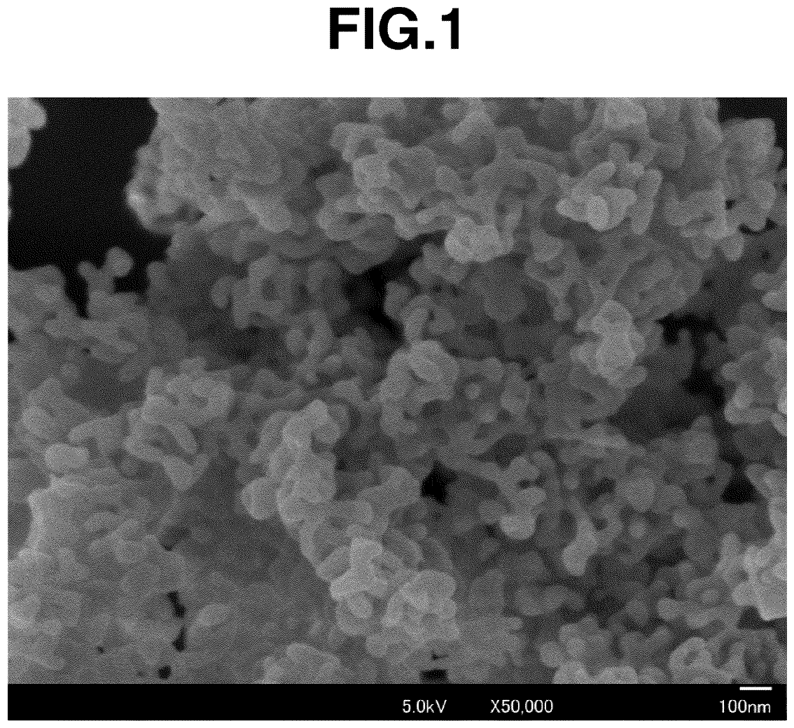

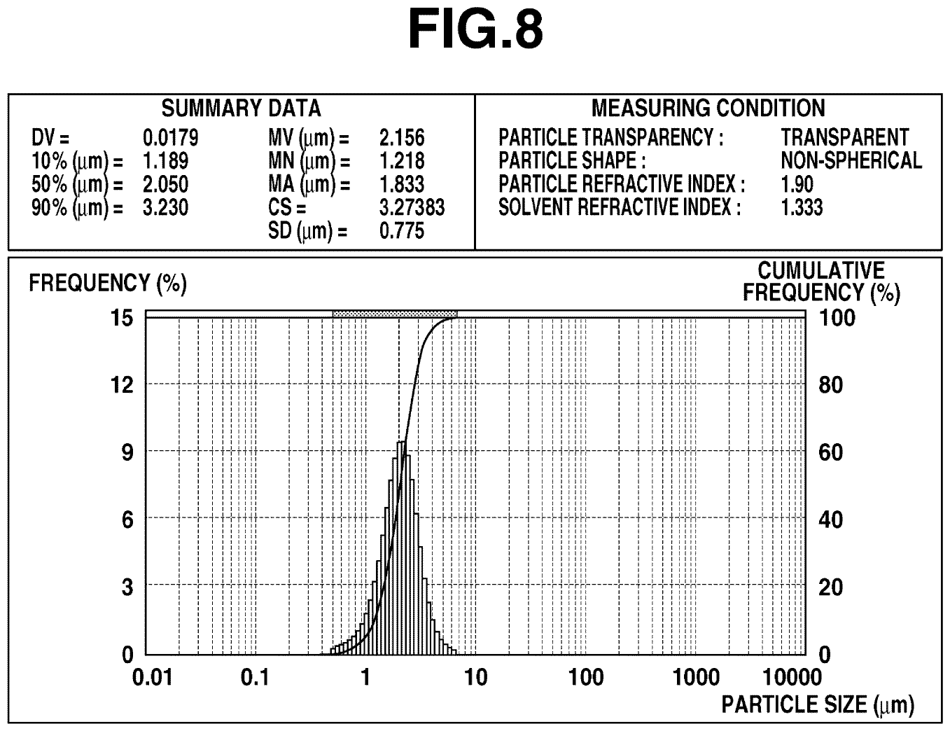

Next, the obtained composite compound particles were calcined under the air at 700° C. for 4 hours. The resulting calcinated product was crushed by a hammer mill, then further calcined at 1100° C. for 2 hours. As a result, particles of yttrium-aluminum composite oxide were obtained. Observation under an electron microscope confirmed that although the particles were connected to each other, the particles had a primary particle size of not more than 0.1 μm with very little particle enlargement. An electron microscope image of the particles is shown in FIG. 1. Further, it was confirmed that the particles were yttrium-aluminum-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer (Microtrack Bell, MT3300). The result is shown in FIG. 8. The median diameter (D50) was 2.05 μm.

### Example 2

An aqueous solution of yttrium nitrate and an aqueous solution of aluminum nitrate were added so that the yttrium ion concentration was 0.06 mol/L, and the aluminum ion concentration was 0.10 mol/L, respectively, in 100 L of the aqueous solutions. Further, citric acid was added at an amount corresponding to 0.2 times of the total ion concentration of yttrium ions and aluminum ions, then the solution was stirred. Next, the solution was heated to 98° C., then urea was added at an amount corresponding to 2.4 mol/L, and the solution was heated at 98° C. for 150 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

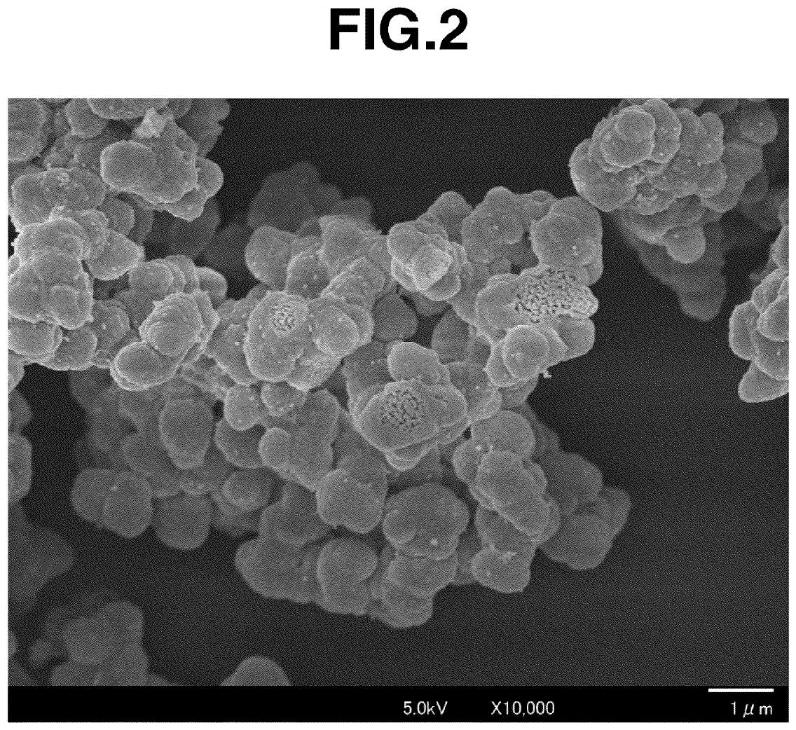

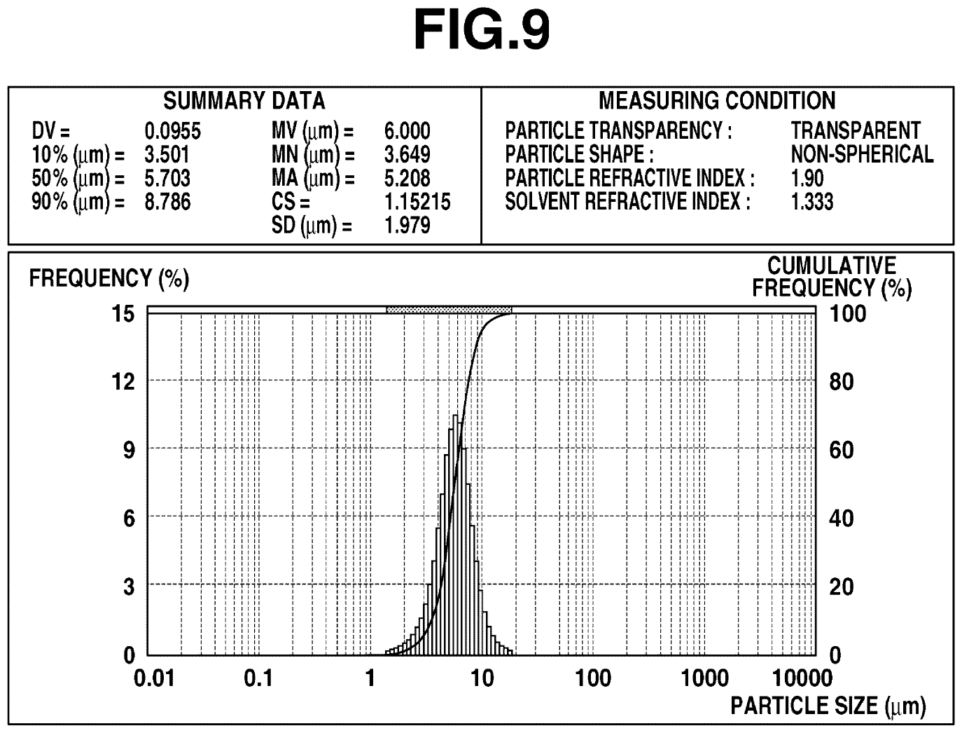

Next, the obtained composite compound particles were calcined under the air at 700° C. for 4 hours. The resulting calcinated product was crushed by a hammer mill, then further calcined at 1100° C. for 2 hours. As a result, particles of yttrium-aluminum composite oxide were obtained. Observation under an electron microscope confirmed that although the particles were connected to each other, the particles had a primary particle size of about 0.3 to 1 μm with very little particle enlargement. An electron microscope image of the particles is shown in FIG. 2. Further, it was confirmed that the particles were yttrium-aluminum-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 9. The median diameter (D50) was 5.70 μm.

### Example 3

An aqueous solution of yttrium nitrate and an aqueous solution of aluminum nitrate were added so that the yttrium ion concentration was 0.10 mol/L, and the aluminum ion concentration was 0.05 mol/L, respectively, in 100 L of the aqueous solutions. Further, maleic anhydride was added at an amount corresponding to 0.5 times of the total ion concentration of yttrium ions and aluminum ions, then the solution was stirred. Next, the solution was heated to 98° C., then urea was added at an amount corresponding to 2.4 mol/L, and the solution was heated at 98° C. for 150 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

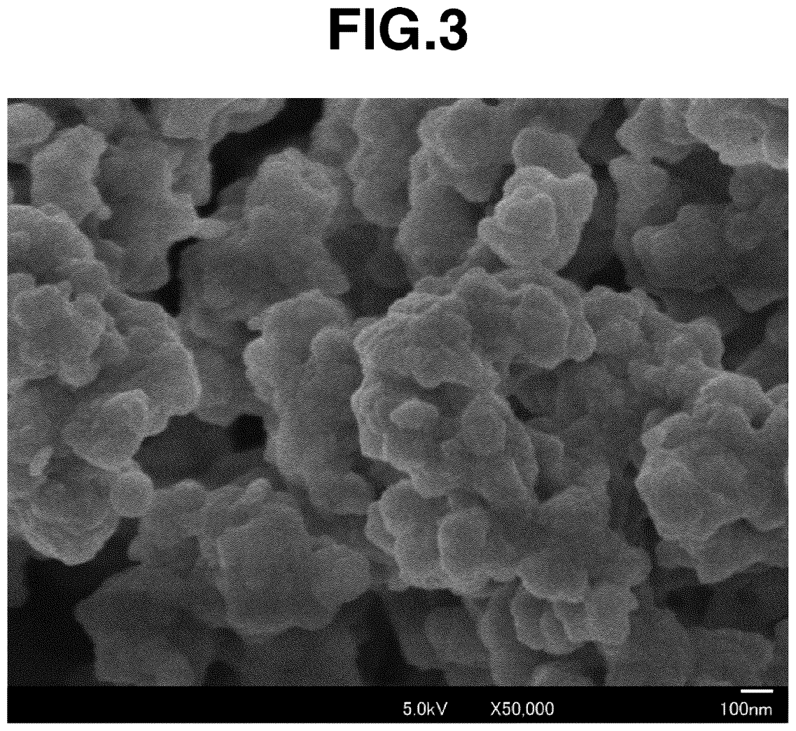

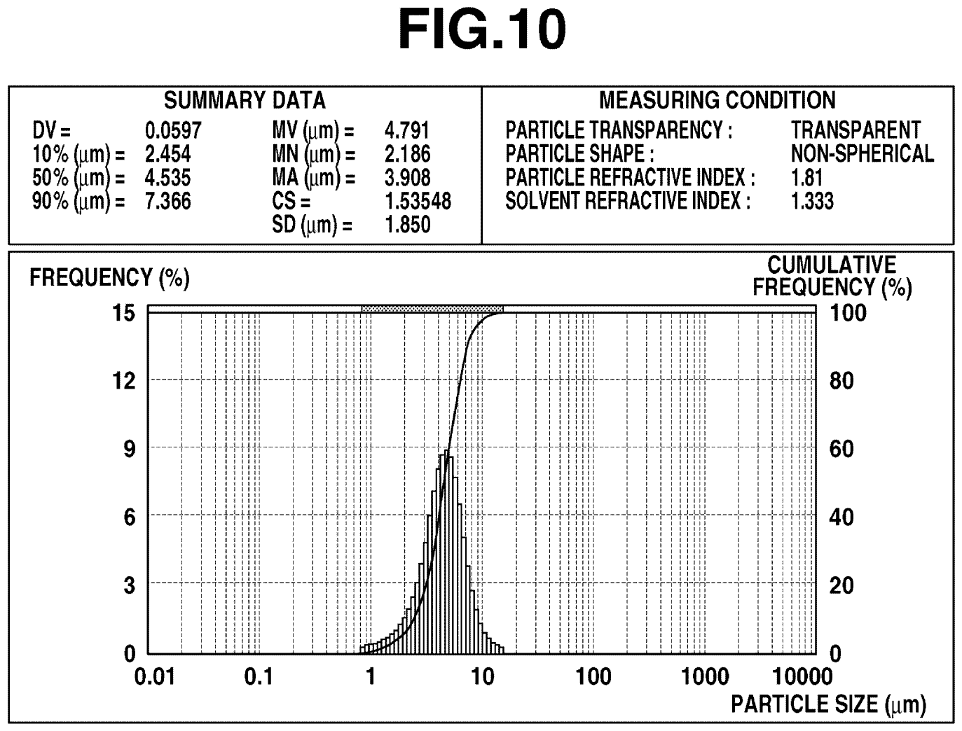

Next, the obtained composite compound particles were calcined under the air at 700° C. for 4 hours. The resulting calcinated product was crushed by a hammer mill, then further calcined at 1000° C. for 2 hours. As a result, particles of yttrium-aluminum composite oxide were obtained. Observation under an electron microscope confirmed that although the particles were connected to each other, the particles had a primary particle size of not more than 0.2 μm with very little particle enlargement. An electron microscope image of the particles is shown in FIG. 3. Further, it was confirmed that the particles were yttrium-aluminum-monoclinic by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 10. The median diameter (D50) was 4.54 μm.

### Example 4

An aqueous solution of yttrium nitrate, an aqueous solution of aluminum nitrate and an aqueous solution of gallium nitrate were added so that the yttrium ion concentration was 0.06 mol/L, the aluminum ion concentration was 0.06 mol/L, and the gallium ion concentration was 0.04 mol/L, respectively, in 100 L of the aqueous solutions. Further, malic acid was added at an amount corresponding to 0.4 times of the total ion concentration of yttrium ions, aluminum ions and gallium ions, then the solution was stirred. Next, the solution was heated to 98° C., then urea was added at an amount corresponding to 2.4 mol/L, and the solution was heated at 98° C. for 165 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

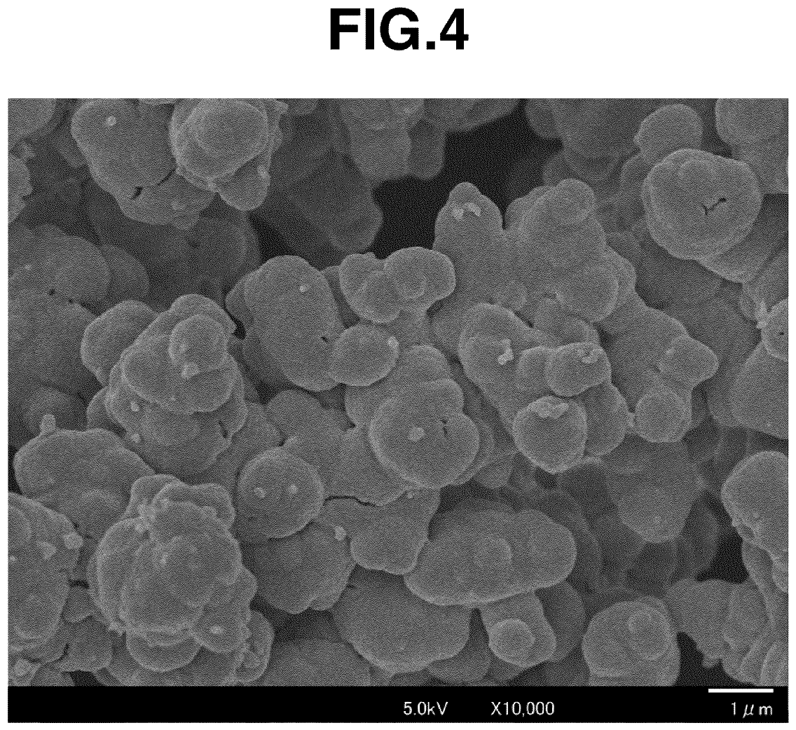

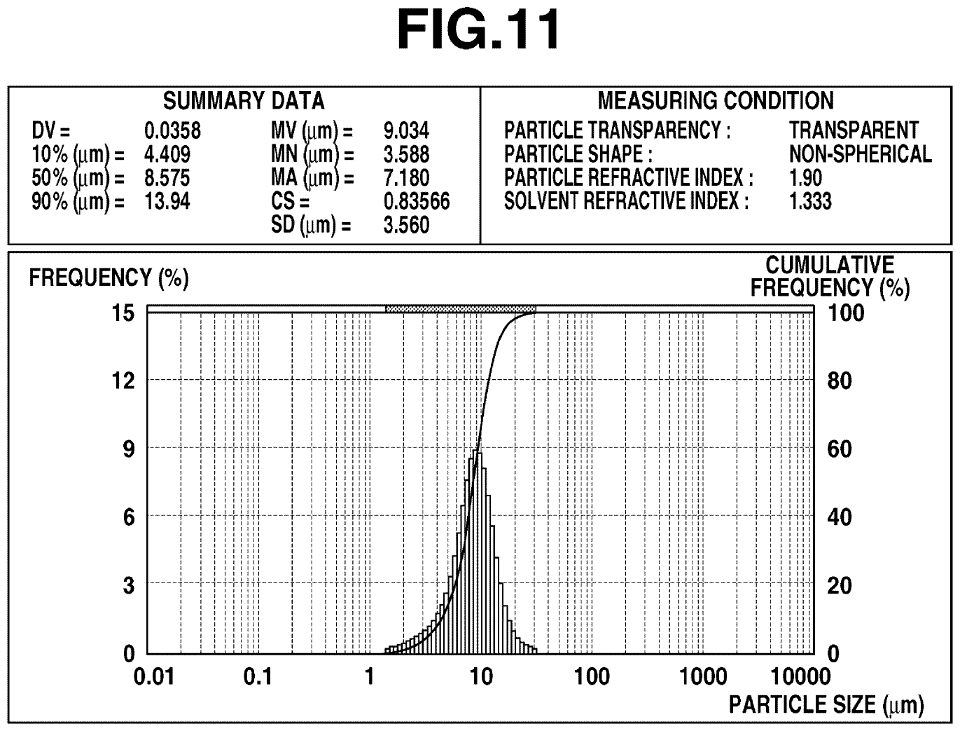

Next, the obtained composite compound particles were calcined under the air at 700° C. for 4 hours. The resulting calcinated product was crushed by a hammer mill, then further calcined at 1100° C. for 2 hours. As a result, particles of yttrium-aluminum gallium composite oxide were obtained. Observation under an electron microscope confirmed that although the particles were connected to each other, the particles had a primary particle size of about 0.5 to 1.5 μm with very little particle enlargement. An electron microscope image of the particles is shown in FIG. 4. Further, it was confirmed that the particles were yttrium-(aluminum, gallium)-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 11. The median diameter (D50) was 8.58 μm.

### Example 5

An aqueous solution of lutetium nitrate and an aqueous solution of aluminum nitrate were added so that the lutetium ion concentration was 0.06 mol/L, and the aluminum ion concentration was 0.10 mol/L, respectively, in 100 L of the aqueous solutions. Further, malic acid was added at an amount corresponding to 0.4 times of the total ion concentration of lutetium ions and aluminum ions, then the solution was stirred. Next, the solution was heated to 98° C., then urea was added at an amount corresponding to 2.4 mol/L, and the solution was heated at 98° C. for 165 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

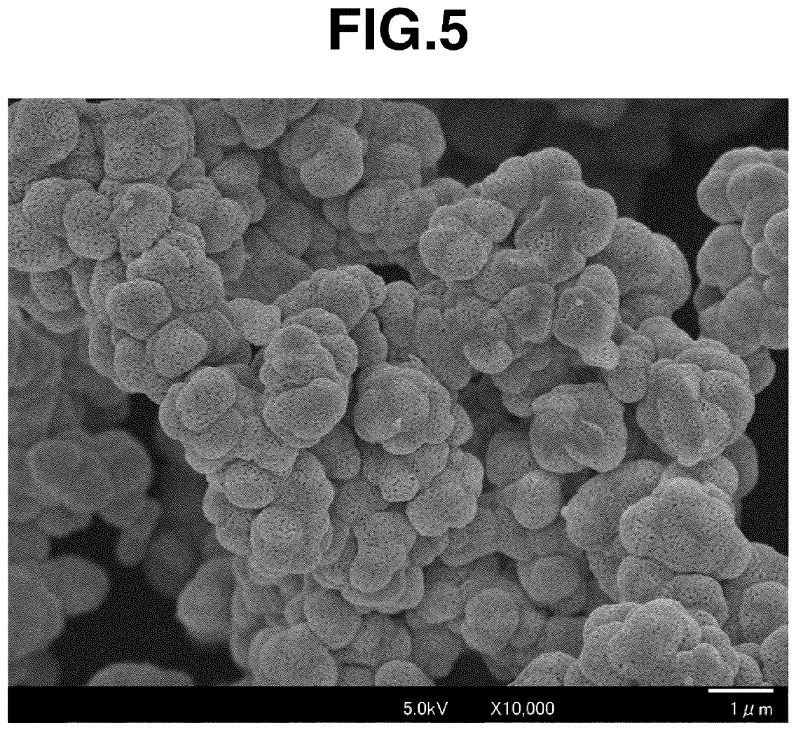

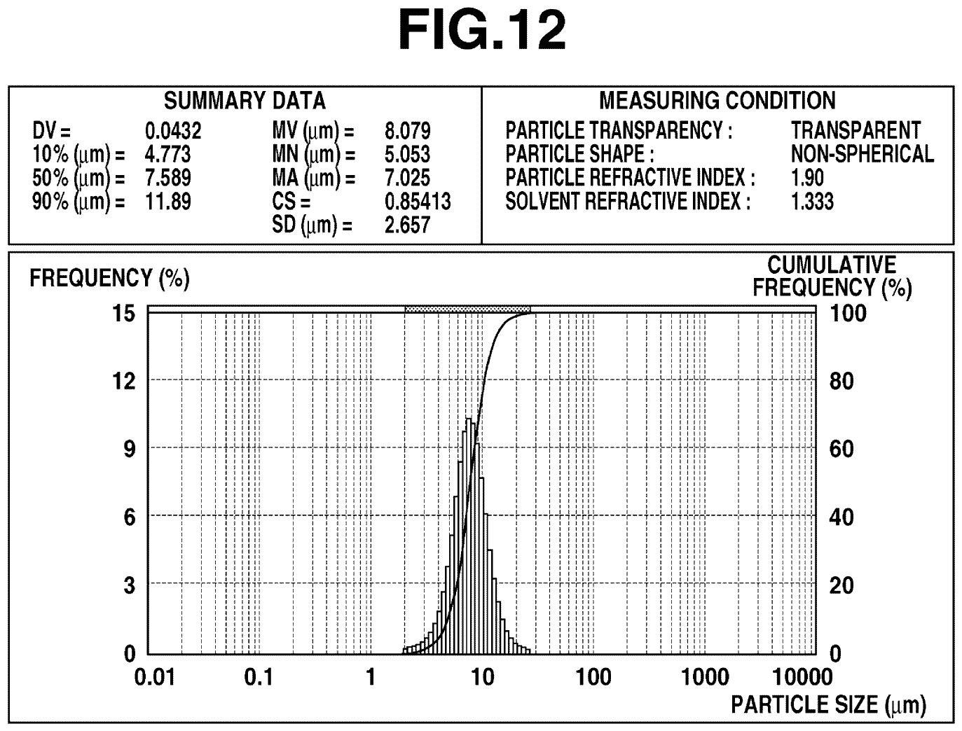

Next, the obtained composite compound particles were calcined under the air at 700° C. for 4 hours. The resulting calcinated product was crushed by a hammer mill, then further calcined at 1100° C. for 2 hours. As a result, particles of lutetium-aluminum composite oxide were obtained. Observation under an electron microscope confirmed that although the particles were connected to each other, the particles had a primary particle size of about 0.5 to 1.5 μm with very little particle enlargement. An electron microscope image of the particles is shown in FIG. 5. Further, it was confirmed that the particles were lutetium-aluminum-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 12. The median diameter (D50) was 7.59 μm.

### Example 6

An aqueous solution of gadolinium nitrate and an aqueous solution of gallium nitrate were added so that the gadolinium ion concentration was 0.06 mol/L, and the gallium ion concentration was 0.10 mol/L, respectively, in 100 L of the aqueous solutions. Further, maleic anhydride was added at an amount corresponding to 0.3 times of the total ion concentration of gadolinium ions and gallium ions, and malic acid was added at an amount corresponding to 0.1 times of the total ion concentration of gadolinium ions and gallium ions, then the solution was stirred. Next, the solution was heated to 98° C., then urea was added at an amount corresponding to 2.4 mol/L, and the solution was heated at 98° C. for 180 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

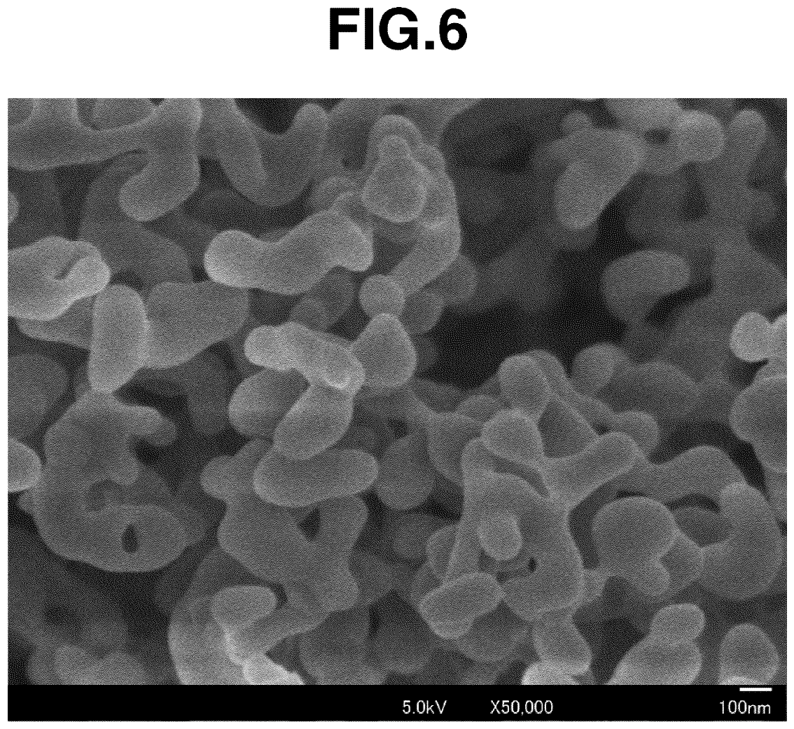

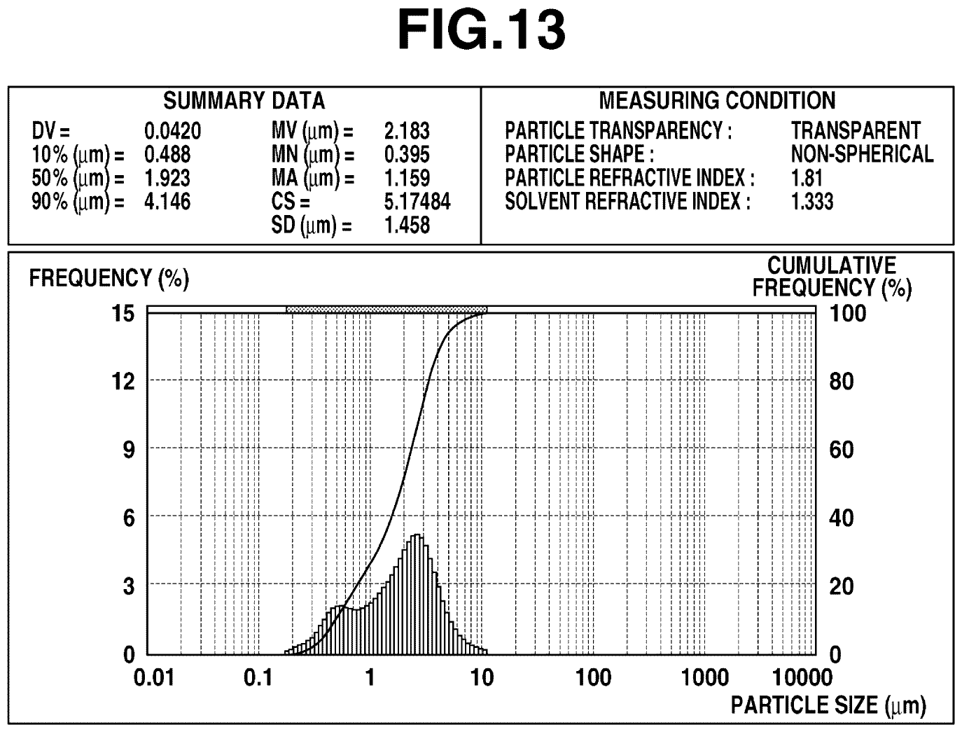

Next, the obtained composite compound particles were calcined under the air at 700° C. for 4 hours. The resulting calcinated product was crushed by a hammer mill, then further calcined at 1100° C. for 2 hours. As a result, particles of gadolinium-gallium composite oxide were obtained. Observation under an electron microscope confirmed that although the particles were connected to each other, the particles had a primary particle size of about 0.1 to 0.3 μm with very little particle enlargement. An electron microscope image of the particles is shown in FIG. 6. Further, it was confirmed that the particles were gadolinium-gallium-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 13. The median diameter (D50) was 1.92 μm.

### Comparative Example 1

An aqueous solution of yttrium nitrate and an aqueous solution of aluminum nitrate were added so that the yttrium ion concentration was 0.06 mol/L, and the aluminum ion concentration was 0.10 mol/L, respectively, in 100 L of the aqueous solutions, then the solution was stirred. Next, the solution was heated to 98° C., then urea was added at an amount corresponding to 2.4 mol/L, and the solution was heated at 98° C. for 150 minutes. As a result, a solid was deposited.

Next, the deposit was separated to solid and liquid by a centrifugal machine, then the collected solid was washed with about 20 L of pure water. It was confirmed that the obtained solid (composite compound particles) was amorphous by X-ray diffraction.

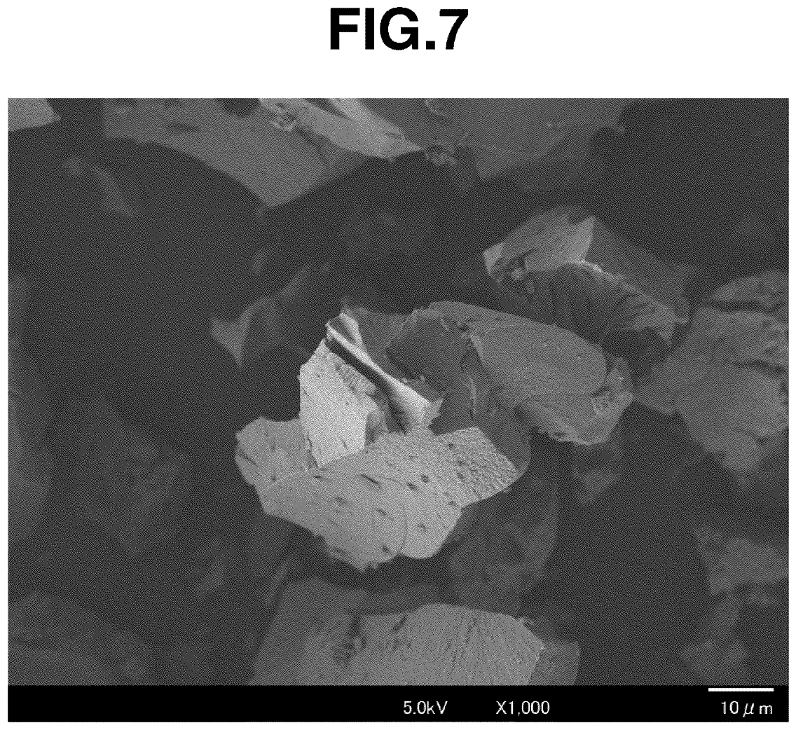

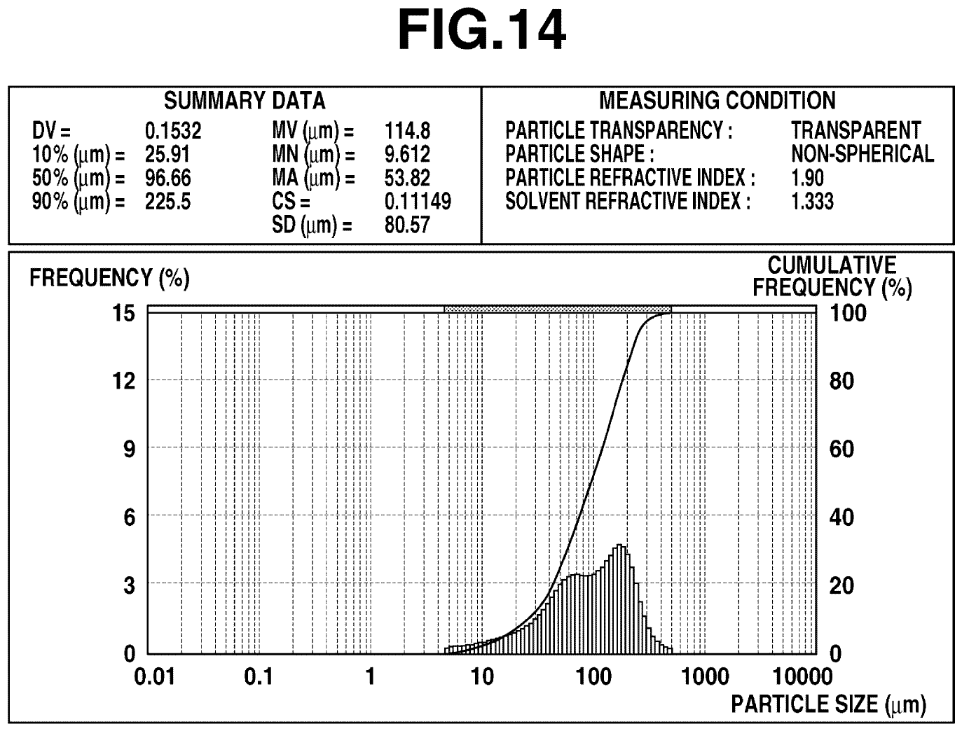

Next, the obtained composite compound particles were calcined under the air at 700° C. for 4 hours. The resulting clumpy solid of calcinated product was too hard to be easily crushed by hands, thus, was crushed in a mortar since crushing by a hammer mill would scratch the hummer and had a risk of contamination, then was further calcined at 1100° C. for 2 hours. As a result, particles of yttrium-aluminum composite oxide were obtained. Observation under an electron microscope confirmed that the particles had a primary particle size of 10 μm or more due to progress of particle enlargement. An electron microscope image of the particles is shown in FIG. 7. Further, it was confirmed that the particles were yttrium-aluminum-garnet by X-ray diffraction. Further, after dispersing the obtained particles into pure water by a homogenizer (40 W, 3 minutes), particle size distribution measurement by a laser diffraction method was performed by a laser diffraction/scattering particle size distribution analyzer MT3300. The result is shown in FIG. 14. The median diameter (D50) was 99.66 μm.

Japanese Patent Application Nos. 2023-199867 and 2024-150443 are incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A preparing method of rare earth composite oxide particles, comprising the steps of:
(A) producing particles of rare earth composite compound by heating an aqueous solution that comprises ions of at least one kind of rare earth element selected from the group consisting of Sc, Y, Nd, Gd, Tb, Dy, Ho, Er, Tm, Yb, and Lu, either or both of Al ions and Ga ions, an organic compound having a carboxy group, and urea at not less than 80° C. and not more than a boiling point of the aqueous solution to react the organic compound, a hydrolyzed product of the urea, the ions of the rare earth element, and the either or both of Al ions and Ga ions, and
(B) producing rare earth composite oxide from the rare earth composite compound.

2. The method of claim 1 wherein the organic compound is an organic compound having at least one carboxy group, or an organic compound having condensed carboxy groups from which carboxy groups are easily formed in the aqueous solution.

3. The method of claim 1 wherein the step (B) comprises the steps of:
separating the particles of the rare earth composite compound obtained in the step (A) by solid-liquid separation, and
calcining the obtained solid under an atmosphere comprising oxygen at not less than 600° C. to produce the rare earth composite oxide.

4. The method of claim 3 for preparing the rare earth composite oxide particles having a volume-based median diameter (D50) of not less than 0.1 μm and not more than 10 μm in particle size distribution measured by a laser diffraction method.

5. The method of claim 1 wherein the organic compound having a carboxy group is at least one kind selected from the group consisting of maleic acid, maleic anhydride, malic acid, and citric acid.

6. The method of claim 5 wherein the step (B) comprises the steps of:
separating the particles of the rare earth composite compound obtained in the step (A) by solid-liquid separation, and
calcining the obtained solid under an atmosphere comprising oxygen at not less than 700° C. to produce the rare earth composite oxide.
